(19) United States
(12) Patent Application Publication
(10) Pub. No.: US 2015/0025686 A1
(43) Pub. Date: Jan. 22, 2015

(54) METHOD OF CORRECTING POSITION ERROR OF AMT ACTUATOR

(71) Applicants: Kia Motors Corp., Seoul (KR); Hyundai Motor Company, Seoul (KR)

(72) Inventor: Young Min Yoon, Seoul (KR)

(73) Assignees: Kia Motors Corp., Seoul (KR); Hyundai Motor Company, Seoul (KR)

(21) Appl. No.: 14/066,319

(22) Filed: Oct. 29, 2013

(30) Foreign Application Priority Data
Jul. 16, 2013 (KR) 10-2013-0083383

(51) Int. Cl. F16H 61/28

(52) U.S. Cl. CPC F16H 61/2807
USPC 700/275

(57) ABSTRACT

A method of correcting a position error of an AMT (automated manual transmission) actuator may include a stuck determination operation of determining whether a stuck phenomenon occurs, the stuck phenomenon being a phenomenon in which a finger that may be being moved by operation of a shifting actuator in a direction in which gears engage with each other stops without reaching an end position, a section determination operation of, when the stuck phenomenon has occurred, determining whether a position at which the finger stops may be within a resetting determination section based on the end position, and a position resetting operation of, when the stuck phenomenon occurs within the resetting determination section, resetting a position at which the stuck phenomenon occurs as a new end position.

### CROSS-REFERENCE TO RELATED APPLICATION

The present application claims priority to Korean Patent Application No. 10-2013-0083383 filed Jul. 16 2013, the entire contents of which is incorporated herein for all purposes by this reference.

### BACKGROUND OF THE INVENTION

1. Field of the Invention

The present invention relates generally to methods of correcting position errors of AMT (automated manual transmission) actuators and, more particularly, to a method of correcting a position error for controlling an actuator of an AMT configured such that gear-shifting operation includes selecting operation of selecting a shift rail assigned to a target speed gear, and shifting operation of moving the selected shift rail and completing the gear-shifting, wherein the selecting operation and the shifting operation are embodied by the actuator.

2. Description of the Related Art

FIG. 1 illustrates gear-shifting mechanism of a conventional automated manual transmission to which the present invention can be applied and, specially, depicts a double clutch transmission.

As shown in FIG. 1, the transmission includes two fingers F which are moved in the vertical direction (when viewed from the drawing) so as to carry out a selecting operation and are rotated to conduct a shifting operation. An odd gear selecting actuator 9 and an even gear selecting actuator 13 respectively move the two fingers F in the vertical direction. An odd gear shifting actuator 11 and an even gear shifting actuator 15 respectively rotate the two fingers F. As shown in FIG. 2, the two fingers F vertically move in respective gear-shifting gate patterns to conduct the selecting operation, and move to the left or right to carry out the shifting operation, thus completing the desired gear-shifting operation.

The odd gear selecting actuator 9 and the even gear selecting actuator 13 are embodied by solenoid actuators, and the odd gear shifting actuator 11 and the even gear shifting actuator 15 include motors. Due to characteristics of the motors, a separate position sensor is required to detect positions of the fingers F in response to the operation of the motors. However, the use of the position sensor increases the production cost, and there are disadvantages in terms of the construction of a package and the weight. Therefore, a method in which a controller can precisely detect the positions of the fingers F without using a separate position sensor is required.

In the conventional technique, the following method has been used to detect the positions of the fingers. When a vehicle starts up, the fingers are controlled such that they are disposed at reference positions. After this is confirmed, the rotation of the motor is calculated based on the confirmed positions to trace the positions of the fingers, thus determining the positions of the fingers.

FIG. 2 illustrates reference positions of the two fingers F. When the vehicle starts up, the fingers F are initialized at the reference positions. Thereafter, the motor is rotated to move the corresponding finger to the left or right by a predetermined stroke, thus conducting the shifting operation.

However, there may be differences between the positions of the fingers that are desired by the controller and the actual positions of the fingers. With regard to such differences, FIG. 3 illustrates eccentricity caused by finger clearance.

Although the controller recognizes that the finger is disposed at the reference position, that is, a neutral position, the finger may be actually disposed at an eccentric position because of finger clearance.

In the vehicle, because of some causes, if the degree of eccentricity caused by the finger clearance is rapidly increased, the controller may determine during the shifting operation that the finger is not moved to a reference position at which the shifting operation is completed, so that gear-shifting may not be able to be completed.

In other words, as shown in FIG. 3, if the finger F is abruptly displaced by finger clearance S from the reference position to the left by a distance C, when the finger is shifted to the left to carry out gear-shifting, in spite of the finger being moved to the left to the max and disposed at the end position, the controller may determine that the gear-shifting is not completed because the stroke of the finger that has been calculated by means of the number of revolutions of the motor cannot be measured to a degree enough to determine that the gear-shifting has been completed.

The information disclosed in this Background of the Invention section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention are directed to providing a method of correcting a position error of an AMT actuator in which when the degree of eccentricity of a finger reference position that is caused by finger clearance is abruptly and largely increased by some cause the eccentricity of the finger can be appropriately compensated for so that the gear-shifting operation can be conducted continuously and smoothly, thus enhancing the reliability and marketability of a vehicle.

In an aspect of the present invention, a method of correcting a position error of an AMT (automated manual transmission) actuator, may include a stuck determination operation of determining whether a stuck phenomenon occurs, the stuck phenomenon being a phenomenon in which a finger that is being moved by operation of a shifting actuator in a direction in which gears engage with each other stops without reaching an end position, a section determination operation of, when the stuck phenomenon may have occurred, determining whether a position at which the finger stops is within a resetting determination section based on the end position, and a position resetting operation of, when the stuck phenomenon occurs within the resetting determination section, resetting a position at which the stuck phenomenon occurs as a new end position.

The resetting determination section of the section determination operation is set as a section from the end position as much as to a maximum value of a finger clearance towards a neutral position.

The maximum value of the finger clearance is set as a value to which the finger can move from the neutral position to a shifting direction to a maximum position when the finger is disposed within a selecting section.

The end position may include a design value, an upper design limit value that is farther than the design value from the neutral position, and a lower design limit value that is closer than the design value to the neutral position, and the position resetting operation may include setting the position at which the stuck phenomenon occurs as a lower design limit value of the new end position.

In a method of correcting a position error of an AMT actuator according to an exemplary embodiment of the present invention, when the degree of eccentricity of a finger reference position that is caused by finger clearance is abruptly and largely increased by some cause, the eccentricity of the finger can be appropriately compensated for so that gear-shifting operation can be conducted continuously and smoothly. Therefore, the reliability and marketability of a vehicle can be enhanced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating gear-shifting mechanism of an automated manual transmission according to a conventional technique.

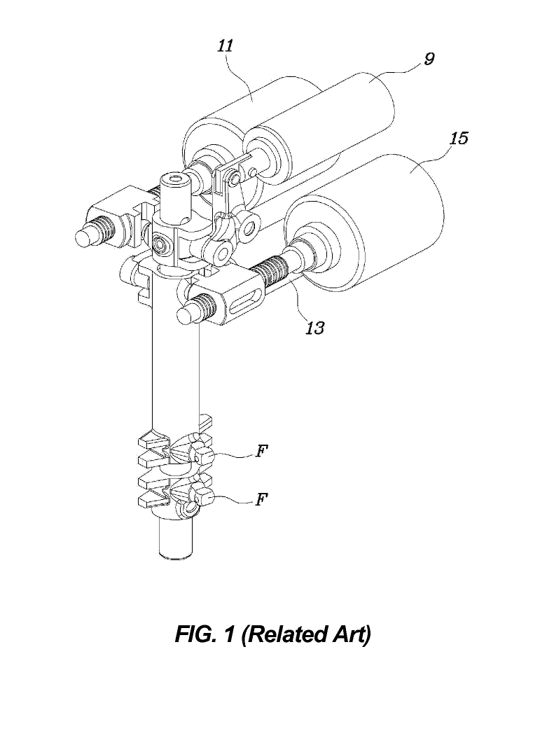

FIG. 2 illustrates a gear-shifting gate pattern and a reference finger position according to the gear-shifting mechanism of FIG. 1.

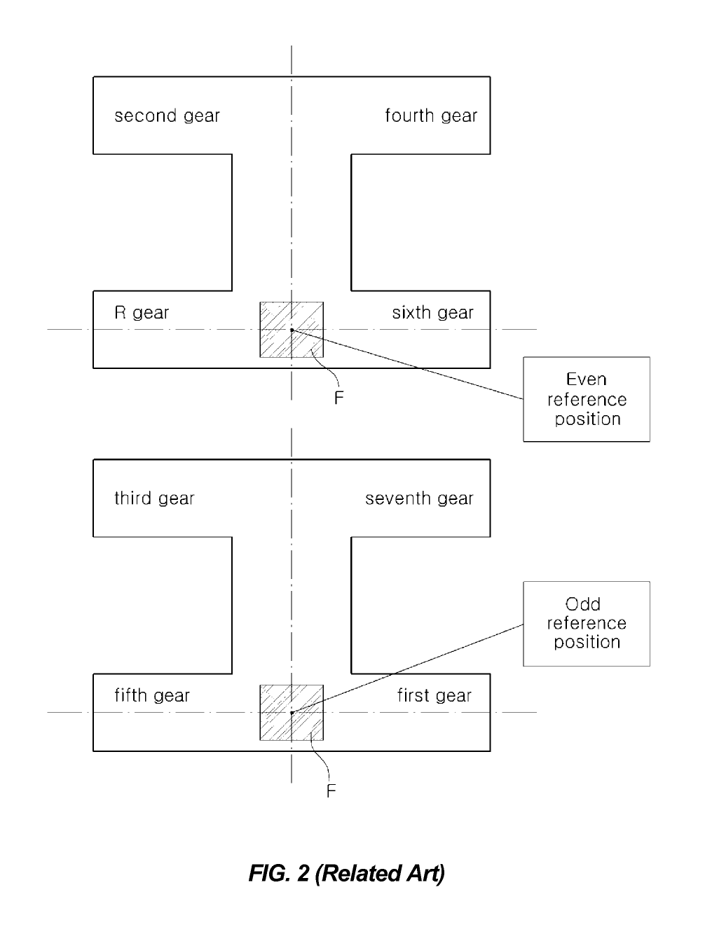

FIG. 3 is a view illustrating eccentricity caused by finger clearance and accompanying problems according to the conventional technique.

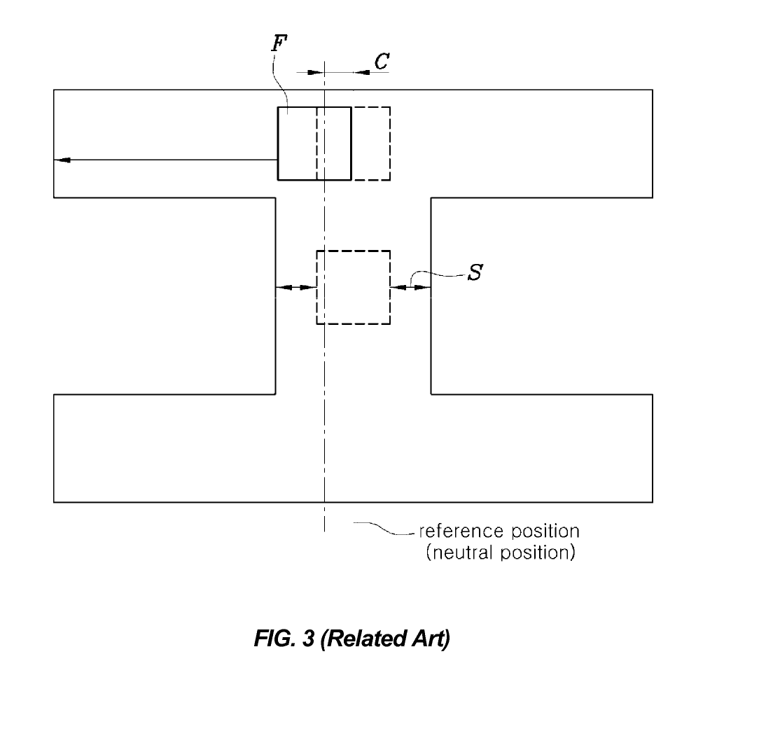

FIG. 4 is a flowchart showing an exemplary embodiment of a method of correcting a position error of an AMT actuator, according to an exemplary embodiment of the present invention.

FIG. 5 is a view illustrating a resetting determination section according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF THE PREFERRED EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an exemplary embodiment of the present invention will be described in detail with reference to the attached drawings.

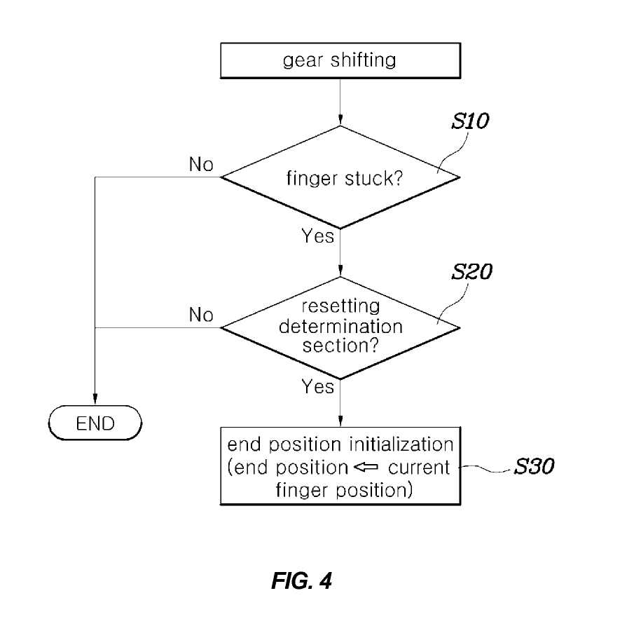

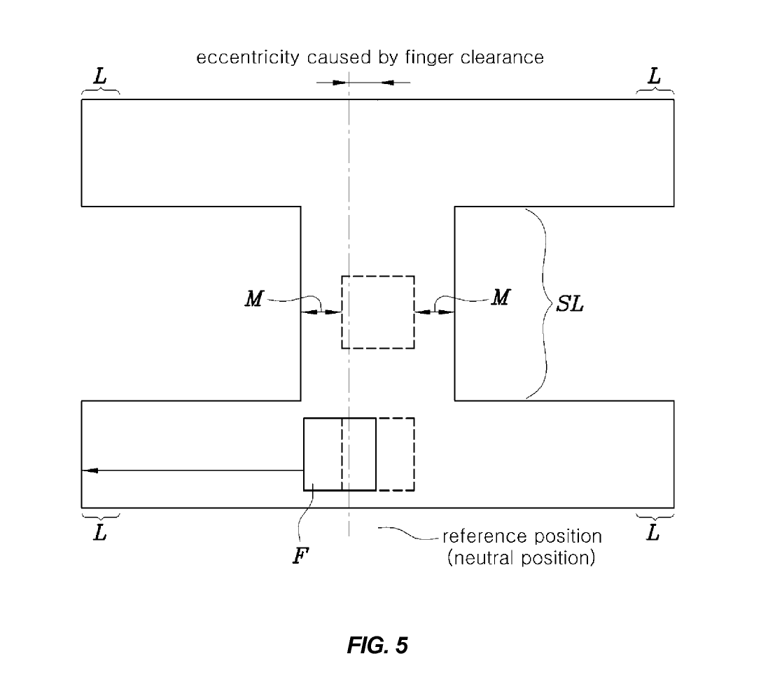

Referring to FIGS. 4 and 5, a method of correcting a position error of an AMT actuator according to an exemplary embodiment of the present invention includes: a stuck determination operation S10 of determining whether a stuck phenomenon has occurred in which a finger which is being moved by operation of a shifting actuator in a direction in which gears engage with each other stops without reaching an end position, a section determination operation S20 of, when the stuck phenomenon has occurred, determining whether the position at which the finger stops is within a resetting determination section L based on the end position, and a position resetting operation S30 of, when the stuck phenomenon occurs within the resetting determination section L, resetting the position at which the stuck phenomenon occurs as a new end position.

In other words, during the shifting operation of moving the finger in the direction in which the gears engage with each other, if a controller determines that the finger has stopped despite the finger not reaching the end position, the controller determines whether the position at which the finger stops is within the resetting determination section L. If it is, the position at which the stuck occurs is set as a new end position. Thereby, a difference between the position of the finger that is recognized by the controller and the real position of the finger can be removed. Eventually, the problem of eccentricity can be solved.

As such, after the position resetting operation S30 has been carried out, the controller determines that the finger has reached the end position and thus is able to normally determine that targeted gear-shifting has been completed.

Preferably, in the section determination operation S20, the resetting determination section L is set as a section from the end position as much as to a maximum value M of the finger clearance towards a neutral position.

That is, the resetting determination section L is used to conduct the position resetting operation S30 when the controller has determined that, despite the fact that the finger has actually reached the end position, the finger does not reach the end position because of the finger clearance. Therefore, it is preferable that the resetting determination section L be set within a range from the end position as much as to the maximum value of the finger clearance towards the neutral position. If it is out of the range, the finger does not actually reach the end position because of other reasons, and there is a high possibility of a stuck phenomenon having occurred. The position resetting operation S30 is also used to exclude this case so that the position resetting operation S30 is not conducted.

As shown in FIG. 5, the maximum value of the finger clearance is set as a value to which the finger can move from the neutral position to the shifting direction to the maximum position when the finger is disposed within a selecting section SL.

Meanwhile, the end position includes a design value, an upper design limit value which is relatively farther than the design value from the neutral position, and a lower design limit value which is relatively closer than the design value to the neutral position. In the position resetting operation S30, it is preferable that the position at which the stuck phenomenon occurs be set as a lower design limit value of a new end position.

That is, although a distance from the neutral position to the end position is determined by the design value, the upper design limit value and the lower design limit value based on the design value are preferably provided in consideration of a tolerance in an actual manufacturing process. In this case, in the position resetting operation S30, if the position at which the stuck phenomenon occurs is set as the lower design limit value of the new end position, a difference between the existing end position and the new end position can be markedly reduced, compared to the case where the position at which the stuck phenomenon occurs is set as the design value. Therefore, side effects caused by rapid end position variation can be minimized.

As described above, a method of correcting a position error of an AMT actuator according to an exemplary embodiment of the present invention can minimize effects of eccentricity, caused by finger clearance which is inevitably required in an automated manual transmission, and automatically compensate for it, thus increasing reliability of gear-shifting operation, thereby enhancing marketability of a vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of correcting a position error of an AMT (automated manual transmission) actuator, comprising:
a stuck determination operation of determining whether a stuck phenomenon occurs, the stuck phenomenon being a phenomenon in which a finger that is being moved by operation of a shifting actuator in a direction in which gears engage with each other stops without reaching an end position;
a section determination operation of, when the stuck phenomenon has occurred, determining whether a position at which the finger stops is within a resetting determination section based on the end position; and
a position resetting operation of, when the stuck phenomenon occurs within the resetting determination section, resetting a position at which the stuck phenomenon occurs as a new end position.

2. The method as set forth in claim 1, wherein the resetting determination section of the section determination operation is set as a section from the end position as much as to a maximum value of a finger clearance towards a neutral position.

3. The method as set forth in claim 2, wherein the maximum value of the finger clearance is set as a value to which the finger can move from the neutral position to a shifting direction to a maximum position when the finger is disposed within a selecting section.

4. The method as set forth in claim 2, wherein the end position comprises a design value, an upper design limit value that is farther than the design value from the neutral position, and a lower design limit value that is closer than the design value to the neutral position, and
the position resetting operation comprises setting the position at which the stuck phenomenon occurs as a lower design limit value of the new end position.
